(19) United States
(12) Patent Application Publication
(10) Pub. No.: US 2024/0032521 A1
(43) Pub. Date: Feb. 1, 2024

(54) Device and System to Remotely Distribute Bait

(71) Applicant: JOHN MICHAEL ELLWOOD, OAK HILL, FL (US)

(72) Inventor: JOHN MICHAEL ELLWOOD, OAK HILL, FL (US)

(21) Appl. No.: 17/878,241

(22) Filed: Aug. 1, 2022

(51) Int. Cl. A01K 85/00

(52) U.S. Cl. CPC A01K 85/1847

(57) ABSTRACT

A device and system to remotely distribute bait is used to attract fish, especially in an off-shore fishing scenario where debris or a “weed line” is spotted. The device is made of a hollow sphere comprising two hemispheres; a loop; slots in the lower hemisphere; a buoyancy material for flotation. A user of a device and system to remotely distribute bait would fill the sphere with bait and select a location desirous of fishing. A user would then throw the device toward the desired location and wait for the chum to fall from the device into the water.

### RELATED APPLICATIONS

This application claims priority to U.S. Provisional Patent Application No. 63/232,488, filed on 12 Aug. 2021 which is incorporated herein by reference in its entirety, including any addendums, appendixes, and attachments thereto, to the extent these applications do not conflict with the present disclosure herein.

### BACKGROUND

The following discussion is not to be deemed admitted prior art but merely related art to show possible background and information related to remotely distributing bait in an environmentally safe manner while fishing.

When fishing offshore a challenge faced by a fishing enthusiast is one of seeing a “weed line” or debris in the water, but at some distance from the boat, and wanting to then fish around this weed line or debris.

When fishing, especially off-shore, the bait is referred to as “chum”. Chum is bait consisting of fish parts, bone and blood.

If a fisherman can add chum to the water near a weed line or debris the odds of catching fish will increase.

Currently, there are solutions to distribute chum in the water. Some of these solutions attempt to connect to a fishing line, like a fishing bobber. Still other solutions may use various doors and compartments to add bait to a box or sphere. Still other solutions may deploy a system like a buoy with anchor lines.

Each of these solutions fail to meet the needed solution because they are difficult to use, cumbersome, unreliable, cannot be tossed a large distance, and interfere with the normal handling and operation of remotely distributing bait in an environmentally safe manner while fishing.

Therefore, a need exists for a novel device and system to remotely distribute bait in an environmentally safe manner while fishing.

### BRIEF SUMMARY OF THE INVENTION

This invention relates generally to, but is not limited to, remotely distributing bait in an

environmentally safe manner while fishing.

With this invention fish can be attracted near weed lines or debris at some distance from a boat and the boat can then be maneuvered into position for casting or trolling.

Disclosed are numerous aspects of a unique device and system to remotely distribute bait.

It is desirable to have a device and system to remotely distribute bait when fishing. Furthermore, it is desirable that a device and system to remotely distribute bait be environmentally safe. Furthermore, it is desirable that a device and system to remotely distribute bait be lightweight and of a size that will allow it to be thrown a considerable distance. Furthermore, it is desirable that a device and system to remotely distribute bait float on the water. Furthermore, it is desirable the components used to make a device and system to remotely distribute bait resist exposure to both fresh water and salt water. Furthermore, it is desirable that a device and system to remotely distribute bait may be retrieved and used again to protect the environment.

The disclosed invention advantageously fills these needs and addresses the aforementioned deficiencies by providing an easy to use, lightweight, softball sized, floating sphere that will distribute bait.

### BRIEF DESCRIPTION OF THE DRAWINGS

A device and system to remotely distribute bait is illustrated by way of example, and not by way of limitation, in the figures of the accompanying drawings.

While aspects of a device and system to remotely distribute bait will be described with reference to the details of the embodiments of the invention shown in the drawings (and some embodiments not shown in the drawings), these details are not intended to limit the scope of the invention.

FIG. 1. A side view of a version of a device and system to remotely distribute bait showing the assembled components.

FIG. 2. A side view of a version of a device and system to remotely distribute bait showing the assembled components, rotated on a polar axis 90 degrees from FIG. 1.

FIG. 3. A perspective view of a version of a device and system to remotely distribute bait showing the assembled components.

FIG. 4. A side view of a version of a device and system to remotely distribute bait

showing the unassembled components.

FIG. 5. A side cutaway view of a version of a device and system to remotely distribute bait showing the assembled components.

FIG. 6. A side cutaway view of a version of a device and system to remotely distribute bait showing the unassembled components.

FIG. 7. A perspective cutaway view of a version of a device and system to remotely distribute bait showing the unassembled components.

FIG. 8. A side view of a version of a device and system to remotely distribute bait assembled and with a keel.

### LIST OF FIGURE ITEMS

000 a device and system to remotely distribute bait

001 an upper hemisphere

002 a lower hemisphere

003 A loop for retrieval

004 Vane, slot, or circular opening for bait to flow outward

006 A material for buoyancy

007 A keel

### DETAILED DESCRIPTION

The order of the steps of disclosed processes may be altered within the scope of the invention.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. A device and system to remotely distribute bait may, however, be embodied in many different forms and should not be construed as being limited to the embodiments set forth herein; rather, these embodiments are provided by way of illustration only and so that this disclosure will be thorough, complete and fully convey understanding to those skilled in the art.

For the purposes of promoting an understanding of the principles of a device and system to remotely distribute bait, reference will now be made to the embodiments illustrated in the drawings and specific language will be used to describe the same, only as examples and not intended to be limiting.

For purposes of discussion the term “slot” as used herein is, but not limited to, a slot, a slit, a hole, an opening, and an aperture.

Disclosed is a device and system to remotely distribute bait, comprising the following components: (1) a hollow sphere 000; (2) material 006 for buoyancy; (3) a plurality of slots 004 (4) a loop 003.

These components generally speaking, are configured as follows: (1) a hollow sphere 000 is threaded and two halves 001, 002, hemispheres, are connected; (2) the upper hemisphere 001 is lined with a material 006 to create buoyancy; (3) the outside of an upper hemisphere 001 a loop 003 is attached to allow retrieval by a gaff or another hook tool; (4) the lower sphere 002 has a plurality of slots to allow distribution of chum.

A device and system to remotely distribute bait may also have one or more of the following: aperture controls on a lower hemisphere 002 to manage the speed of bait distribution through the slots 004; a keel 007 for stability control; a flotation mechanism at the “equator”; a flag or visual indicator for easier spotting; a sealed upper hemisphere for buoyancy.

The disclosed device and system to remotely distribute bait is unique when compared with other known devices and solutions because it provides: (1) for operation without interfering with how the fishing rod and reel are used by the operator; (2) is reusable and protects the environment; (3) has a loop for easy retrieval; (4) uses buoyancy material on the inside of the sphere; (5) is of a size to be thrown safely into the water.

The disclosed device and system to remotely distribute bait is unique in that it is structurally different from other known devices or solutions. More specifically, the device is unique due to the presence of (1) two hemispheres designed to fasten together; (2) slots in a lower hemisphere that can be controlled; (3) buoyancy material applied to an upper hemisphere;

and (4) a sealed upper hemisphere.

In some embodiments of versions of a device and system to remotely distribute bait a hollow sphere 000 may vary in size, for example, and not meant to be limiting, having a diameter of 2 cm to 35 cm (approximately 2 inches to 14 inches) and a thickness of 0.15 cm to 1.0 cm (approximately 1/16th inch to ⅜th inch).

In some embodiments of versions of a device and system to remotely distribute bait a hollow sphere 000 may be made of materials like, but not limited to, metal, plastic, polyethylene, fiberglass, rubber, foam, PVC (polyvinyl acetate), EVA (ethylene-vinyl acetate), laminated cardboard, carbon fiber, and bamboo.

In some embodiments of a device and system to remotely distribute bait the hemispheres 001, 002 are threaded, to allow them to connect together.

In some embodiments of a device and system to remotely distribute bait the hemispheres 001, 002 use a snap-lock fastener to allow them to connect together.

In some embodiments of a device and system to remotely distribute bait the inside of an upper hemisphere 001 has an application of a buoyancy material 006, such as, but not limited to foam, or a closed-cell foam structure.

In some embodiments of a device and system to remotely distribute bait an upper hemisphere 001 is solid across its open half, typically referred to as the base area of a hemisphere, to create an air chamber to provide buoyancy.

In some embodiments of a device and system to remotely distribute bait the loop 003 may be made of materials like, but not limited to, nylon webbing material, high density polyester weaving, metal, or rubber.

In some embodiments of a device and system to remotely distribute bait the loop 003 may be made of materials like, but not limited to, nylon webbing material, high density polyester weaving, metal, or rubber.

In some embodiments of a device and system to remotely distribute bait the loop 003 may be of a size, not meant to be limiting, of 0.6 cm to 2.5 cm (approximately 0.25 inches to 1 inch) in diameter. The length of the loop 003 may be, not meant to be limiting, from 0.6 cm to 2.5 cm (approximately 2 to 12 inches).

In some embodiments of a device and system to remotely distribute bait the loop may have a bobber or flotation device if the loop is made of a pliable or fabric-like material.

In some embodiments of a device and system to remotely distribute bait these components are connected as follows to result in a single system: (1) the two hemispheres 001, 002 are threaded together; (2) the loop 003 on an upper hemisphere 001 is attached with a fastener on each end to hold it securely in place; (3) the buoyancy material 006 is applied to the inside of an upper hemisphere 001; (4) a weighted keel 007 is connected to a lower hemisphere 002; (5) a flotation bobber is connected to the loop 003.

Some embodiments of a device and system to remotely distribute bait in its most complete version comprises the following components: (1) two hemispheres 001, 002; (2) a material lining 006 on the inside of an upper hemisphere 001 to provide buoyancy; (3) a sealed upper hemisphere 001 at its base; (4) a loop 003 on the outside of an upper hemisphere 001 for retrieval; (5) a flotation bobber on the loop 003; and (6) a weighted keel 007 on the bottom lower hemisphere 002.

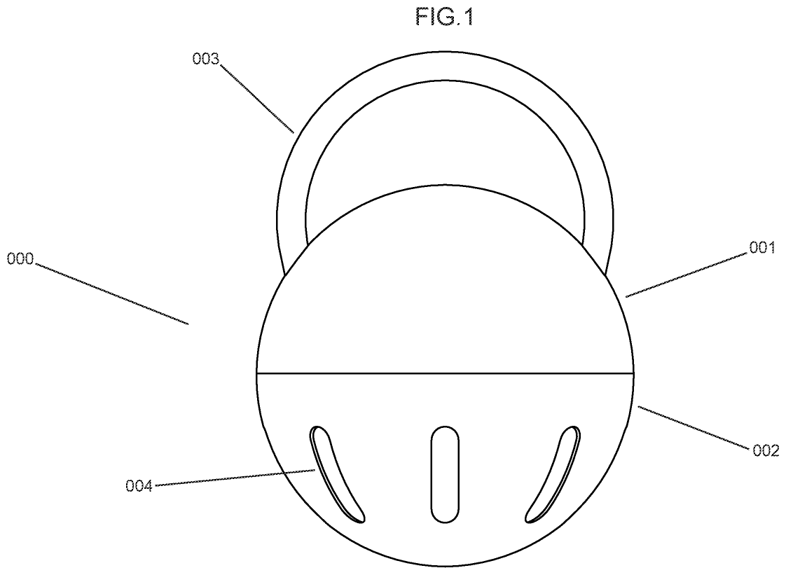

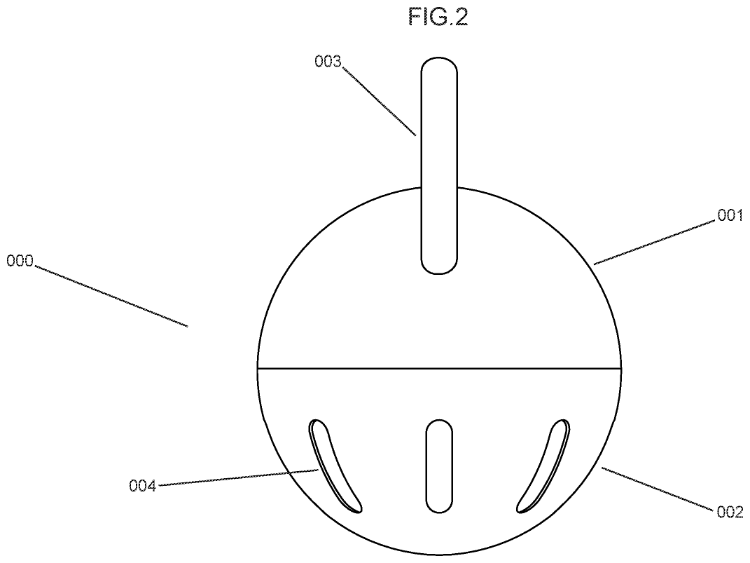

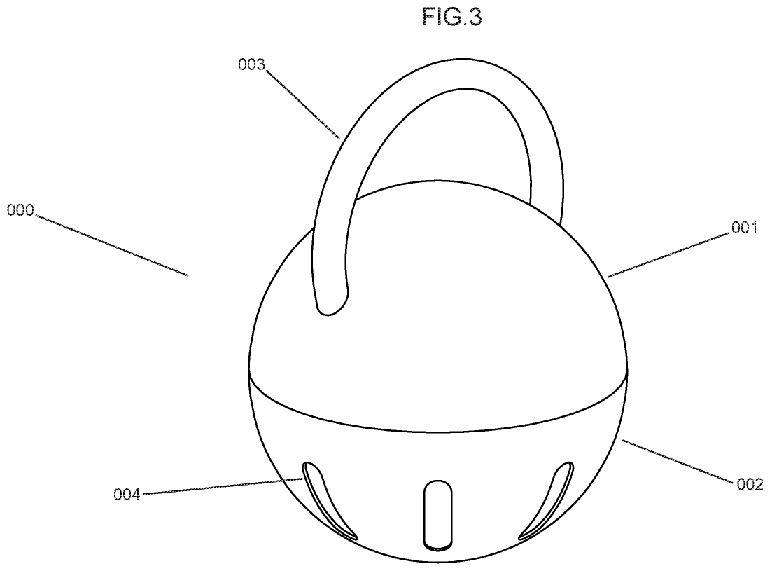

FIG. 1. A side view; FIG. 2. A side view of a version of a device and system to remotely 160 distribute bait showing the assembled components, rotated 90 degrees from FIG. 1.; FIG. 3. A perspective view of a version of a device and system to remotely distribute bait showing the assembled components. Some versions comprise a lower hemisphere 002 connected to an upper hemisphere 001; a loop 003 connected to an upper hemisphere; slots 004 in a lower hemisphere 002 for the bait to flow out into the water.

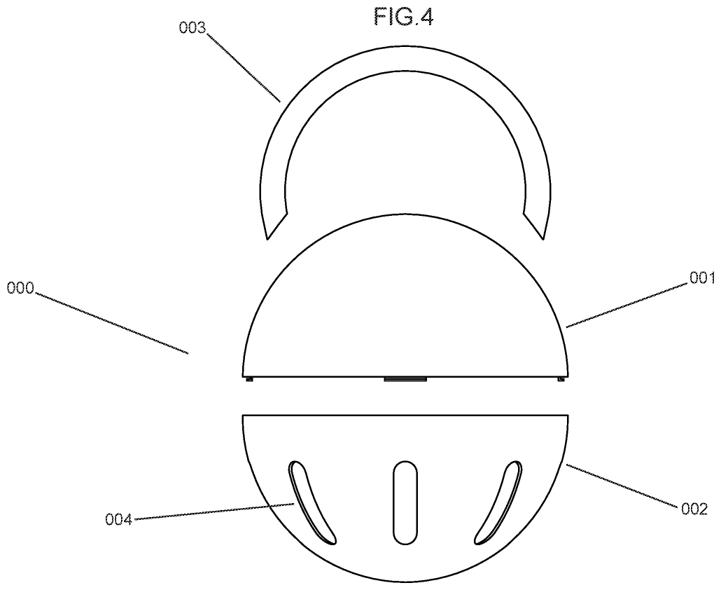

FIG. 4. A side view of a version of a device and system to remotely distribute bait showing the unassembled components. Some versions comprise an upper hemisphere 001; a lower hemisphere 002; a method to connect to two hemispheres; a loop 003; slots 004 in a lower hemisphere.

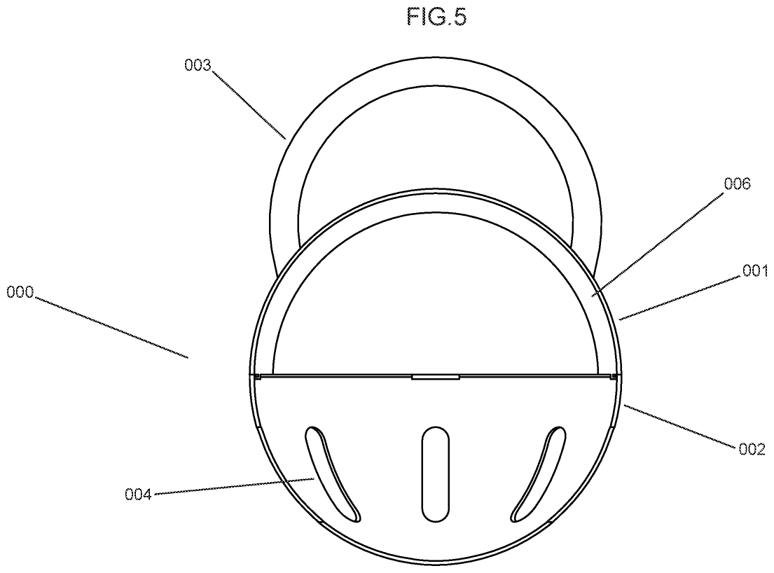

FIG. 5. A side cutaway view of a version of a device and system to remotely distribute bait showing the assembled components. Some versions comprise a lower hemisphere 002 connected to an upper hemisphere 001; a loop 003 connected to an upper hemisphere; slots 004 in a lower hemisphere 002 for the bait to flow out into the water; a material 006 for buoyancy.

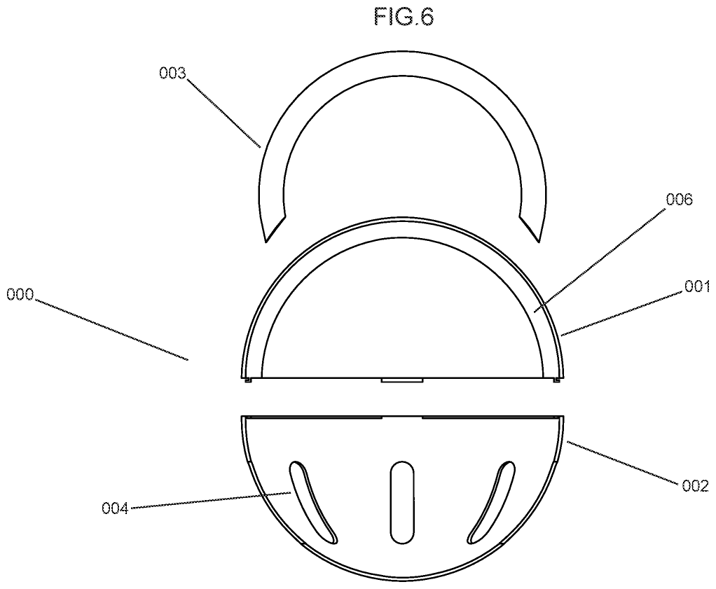

FIG. 6. A side cutaway view of a version of a device and system to remotely distribute bait showing the unassembled components. Some versions comprise a lower hemisphere 002; an upper hemisphere 001; a loop 003; slots 004 in a lower hemisphere 002 for the bait to flow out into the water; a material 006 for buoyancy.

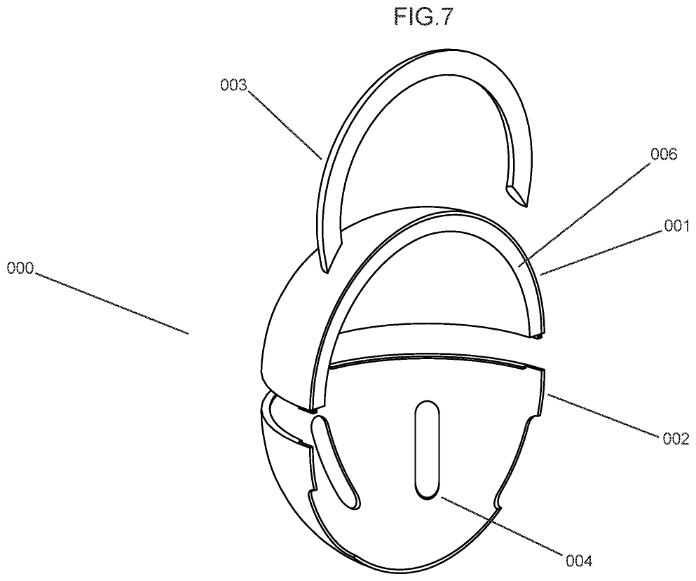

FIG. 7. A perspective cutaway view of a version of a device and system to remotely distribute bait showing the unassembled components. Some versions comprise a lower hemisphere 002; an upper hemisphere 001; a loop 003; slots 004 in a lower hemisphere 002 for the bait to flow out into the water; a material 006 for buoyancy.

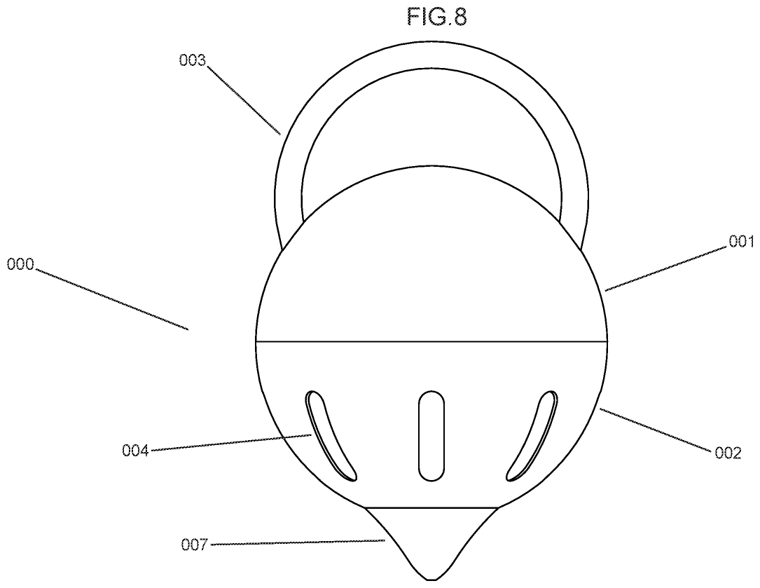

FIG. 8. A side view of a version of a device and system to remotely distribute bait assembled and with a keel. Some versions comprise a lower hemisphere 002 connected to an upper hemisphere 001; a loop 003 connected to an upper hemisphere; slots 004 in a lower hemisphere 002 for the bait to flow out into the water; a material 006 for buoyancy; a keel 007.

FIG. 9. A photograph side view of a version of a device and system to remotely distribute bait assembled.

FIG. 10. A photograph at an angle of a version of a device and system to remotely distribute bait assembled.

FIG. 11. A photograph at an angle of a version of a device and system to remotely distribute bait assembled.

FIG. 12. A photograph of the bottom of a version of a device and system to remotely distribute bait assembled.

FIG. 13. A photograph of two hemispheres of a version of a device and system to remotely distribute bait assembled.

A version of the invention may be a method of adapting a fishing rod with a device and system to remotely distribute bait, comprising: selecting a location to distribute the bait; a sphere 000 made of two hemispheres 001, 002; a buoyancy material 006 on the inside of an upper hemisphere 001 to improve flotation; a loop 003 on the outside of an upper hemisphere 001 for retrieval; a weighted keel 007 on the bottom lower hemisphere 002.

Versions of a device and system to remotely distribute bait may be made individually, in batches, or via continuous assembly.

For example, to make a version of a device and system to remotely distribute bait prepare an appropriate work surface and assemble all of the components disclosed herein. Assemble the components in a logical order as someone skilled in the art would do. For example, start with one hemisphere 001 of the sphere 000 and ensure it is threaded (male or female) or has a snap lock fitting; apply a buoyancy material 006 to the inside of an upper hemisphere 001; select the other hemisphere 002 and ensure there are slots 004 to allow the bait to flow out; if desired attach the keel 007 to a lower hemisphere 002 with a fastener; attach the loop 003 to an upper hemisphere 001 with two fasteners; connect the two hemispheres 001, 002.

An example of using a device and system to remotely distribute bait would be identifying a suitable location requiring chum and throwing a device and system to remotely distribute bait toward the location. After allowing the device and system to float in the water the area can then be fished either by trolling or casting toward it. The device and system to remotely distribute bait can then be retrieved and used again by hooking the loop.

To use the assembled version of a device and system to remotely distribute bait select a location requiring bait; separate the two hemispheres from one another and fill a lower hemisphere with bait; connect the two hemispheres by screwing the halves together; hold the sphere in one's throwing hand; throw the remote bait distribution system toward the selected location; allow time for the bait to disperse; then fish the area where the bait has dispersed.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

The embodiments of a device and system to remotely distribute bait may be utilized individually, concurrently, or in any sequential combination.

Those skilled in the art to which this application relates will appreciate that other and further additions, deletions, substitutions and modifications may be made to the described embodiments.

The specification is not to be taken in a limiting sense, but is made merely for the purpose of describing the general principles of exemplary embodiments; many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

The invention is described with such embodiments, but the invention is not limited to any embodiment. The scope of the invention is limited only by the claims and the invention encompasses numerous alternatives, modifications and equivalents. Several specific details are set forth in the description to provide a thorough understanding of the invention. These details are provided for the purpose of example and the invention may be practiced according to the claims without some or all of these specific details. In general, the order of the steps of disclosed processes may be altered within the scope of the invention.

Unless otherwise indicated, the drawings are intended to be read (e.g., arrangement of parts, proportion, degree, etc.) together with the specifications, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means alone, B alone, C alone, and B together, and C together, B and C together, or A, B and C together. The terms “a” or “an” entity refers to one or more of that entity. As such, the terms “a” (or “an”), “one or more” and “at least one” can be used interchangeably herein.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

What is claimed is:

1. A device and system to remotely distribute bait, comprising:
a hollow sphere of a given thickness, and diameter; further comprising
an upper hemisphere;
a lower hemisphere; and
a loop of a given thickness, and length connected to the hollow sphere;
a plurality of slots in the lower hemisphere.

2. The device and system to remotely distribute bait of claim 1 wherein the upper hemisphere further comprising:
a material for buoyancy.

3. The device and system to remotely distribute bait of claim 1 wherein the upper hemisphere further comprising:
a solid base area as to create a sealed chamber.

4. The device and system to remotely distribute bait of claim 1 wherein the upper hemisphere and the lower hemisphere are fastened together by a threaded fastener.

5. The device and system to remotely distribute bait of claim 1 wherein the hollow sphere is made from a material selected from the group consisting of metal, plastic, polyethylene, fiberglass, rubber, foam, PVC (polyvinyl acetate), EVA (ethylene-vinyl acetate), laminated cardboard, carbon fiber, and bamboo.

6. (canceled)

7. A method of distributing bait with the device and system of any one of claims 1-5 to remotely distribute bait, the method comprising:
assembling components of the device and system;
throwing toward an appropriate location to distribute bait in water, the device, and system to remotely distribute and disperse bait in the water.
